(19) United States
(12) Patent Application Publication
(10) Pub. No.: US 2002/0004097 A1
(43) Pub. Date: Jan. 10, 2002

(54) Food composition

(76) Inventor: Jesus Zamora, Downey, CA (US)

Correspondence Address: Matthew J. Peirce, Esq., 1550 Starlight Canyon Avenue, Las Vegas, NV, 89123, US

(21) Appl. No.: 09/863,242

(22) Filed: May 22, 2001

Related U.S. Application Data
(60) Provisional application No. 60/206,816, filed on May 25, 2000.

(51) Int. Cl. A23L 1/221

(52) U.S. Cl. 426/650; 426/490

(57) ABSTRACT

A new and improved edible food composition is disclosed that serves as a hot sauce or “salsa.” The food composition would serve to spice up the flavor in whatever food the present invention would be utilized with. The flavor and aroma of the present invention are unique, while at the same time, the present invention is very spicy.

### I. BACKGROUND OF THE INVENTION

The present invention concerns that of a new and improved edible food composition that would serve as a salsa or a hot sauce when eaten.

### II. DESCRIPTION OF THE PRIOR ART

U.S. Pat. No. 5,441,757, issued to Huang et al., discloses a sauce composition which is suitable for preparing firm textured starch-containing or vegetable products wherein said products are retorted in the sauce.

U.S. Pat. No. 5,298,270, issued to Morgan, discloses a novel system of barbecue cooking, processing, packaging, and storage of meats such as ribs and chicken is described.

U.S. Pat. No. 4,472,448, issued to Haggerty et al., discloses the process of emulsification and stabilization of fat in meat-in-sauce, meat-in-gravy and meat filling foods which are heat processed.

### III. SUMMARY OF THE INVENTION

The present invention concerns that of a new and improved edible food composition that could be termed a “hot Mexican sauce.” The present invention would serve to spice up the flavor in whatever food the present invention would be utilized with. The flavor and aroma of the present invention are unique, while at the same time, the present invention is very spicy.

There has thus been outlined, rather broadly, the more important features of a food composition in order that the detailed description thereof that follows may be better understood and in order that the present contribution to the art may be better appreciated. There are, of course, additional features of the food composition that will be described hereinafter and which will form the subject matter of the claims appended hereto.

In this respect, before explaining at least one embodiment of the food composition in detail, it is to be understood that the food composition is not limited in its application to the details of construction and to the arrangements of the components set forth in the following description or illustrated in the drawings. The food composition is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present food composition. It is important, therefore, that the claims be regard as including such equivalent constructions insofar as they do not depart from the spirit and scope of the present invention.

It is therefore an object of the present invention to provide a food composition which has all of the advantages of the prior art and none of the disadvantages.

It is another object of the present invention to provide a food composition which may be easily and efficiently manufactured and marketed.

It is another object of the present invention to provide a food composition which is tasty and pleasing to a human palate.

It is yet another object of the present invention to provide a food composition which is economically affordable and available for the buying public.

Other objects, features and advantages of the present invention will become more readily apparent from the following detailed description of the preferred embodiment when considered with the appended claims.

### IV. DESCRIPTION OF THE PREFERRED EMBODIMENT

The recipe listed below would be the preferred embodiment of the food composition, which would create a hot sauce or “salsa” with it's own unique flavors.

| Ingredient | Amount |
|---|---|
| Whole majoran | 1 ounce |
| Whole black pepper | 1 ounce |
| Whole clove | 1 ounce |
| Whole ginger | 0.2 ounce |
| Cinnamon sticks | 0.3 ounce |
| Whole nutmeg | 0.1 ounce |
| Whole garlic | 3 ounces |
| Salt | 2 ounces |
| Arbol chile pods | 14 ounces |
| Water | 1 gallon |

A user would begin by mixing all of the above ingredients together, except for 1 ounce of salt, and blend the combination to a liquefied state. Next, the user would use a very fine strainer and empty the contents of the blender into a container. Then, the residues remaining in the strainer would be returned to the blender and then a user would add liquid from the container and blend the residues for 1 minute. Then, the contents of the blender would be strained into the container and the residues would be thrown away.

The resulting liquid should be allowed to stand for 24 hours. Then, the one ounce of salt previously set aside would be added. Then, the resulting liquid should be allowed to stand for 48 hours or until fermentation is done, at which time, bottling the product is done.

In order to preserve the flavor and aroma of the sauce from changing, all the ingredients used in the above invention must be 100% Mexican grown products.

After preparing 1 gallon of the present invention, approximately 112 ounces of the present invention would be obtained. The present invention could then be bottled in various possible combinations for distribution and eventual use.

The cinnamon and cloves in the food composition would serve to give the present invention a flavor and aroma not present in the prior art and would give the food composition a unique taste. At the same time, the arbol chile pods would make the food composition very hot and pleasing to aficionados of spicy hot sauces and salsas.

What I claim as my invention is:

1. A food composition comprising the following ingredients:

| | |
|---|---|
| Whole majoran | 1 ounce |
| Whole black pepper | 1 ounce |
| Whole clove | 1 ounce |
| Whole ginger | 0.2 ounce |
| Cinnamon sticks | 0.3 ounce |
| Whole nutmeg | 0.1 ounce |
| Whole garlic | 3 ounces |
| Salt | 2 ounces |
| Arbol chile pods | 14 ounces |
| Water | 1 gallon |

2. A process of making a food composition comprising the steps of:
(a) adding the following ingredients together in a first container:

| | |
|---|---|
| Whole majoran | 1 ounce |
| Whole black pepper | 1 ounce |
| Whole clove | 1 ounce |
| Whole ginger | 0.2 ounce |
| Cinnamon sticks | 0.3 ounce |
| Whole nutmeg | 0.1 ounce |
| Whole garlic | 3 ounces |
| Salt | 1 ounce |
| Arbol chile pods | 14 ounces |
| Water | 1 gallon, |

(b) blending the ingredients in a blender to a liquefied state,
(c) straining the liquefied mixture with a strainer into a second container,
(d) removing the residues in the strainer into a blender,
(e) adding a volume of liquid from the liquefied mixture into the blender,
(f) blending the residues and volume of liquid from the liquefied mixture in a blender for one minute,
(g) straining the contents within the blender into the second container,
(h) allowing the resulting composition to stand for twenty-four hours,
(i) adding one ounce of salt to the resulting composition, and
(j) allowing the resulting composition to remain for forty-eight hours or until fermentation of the resulting composition has occurred.
